(19) United States
(12) Patent Application Publication
(10) Pub. No.: US 2015/0296299 A1
(43) Pub. Date: Oct. 15, 2015

(54) ARRANGEMENT AND METHOD FOR IDENTIFYING AND COMPENSATING NONLINEAR VIBRATION IN AN ELECTRO-MECHANICAL TRANSDUCER

(71) Applicant: Wolfgang Klippel, Dresden (DE)

(72) Inventor: Wolfgang Klippel, Dresden (DE)

(21) Appl. No.: 14/683,351

(22) Filed: Apr. 10, 2015

(30) Foreign Application Priority Data
Apr. 11, 2014 (DE) 10 2014 005 381.4

(51) Int. Cl. H04R 3/04

(52) U.S. Cl. CPC H04R 3/04

(57) ABSTRACT

The invention relates to an arrangement and a method for converting an input signal v into an output signal p(rₐ) by using an electro-mechanical transducer and for reducing nonlinear total distortion p_{d} in said output signal p(rₐ), whereas the nonlinear total distortion p_{d} contains multi-modal distortion u_{d} which are generated by nonlinear partial vibration of mechanical transducer components. An identification system generates distributed parameters P_{d} of a nonlinear wave model (N_{d}) and lumped parameters Pₗ of a network model (Nₗ) based on electrical, mechanical or acoustical state variables of transducer measured by a sensor. The nonlinear wave model distinguishes between activation modes and transfer modes, whereas the activation modes affect the transfer modes, which transfer the input signal u into the output signal p. A control system synthesizes based on the physical modeling and identified parameters P_{d} and Pₗ nonlinear distortion signals v_{d} and vₗ which are supplied with the input signal v to the transducer and compensate for the distortion signals uₗ and u_{d} generated by the transducer nonlinearities.

### FIELD OF THE INVENTION

The invention generally relates to arrangements and methods for converting an input signal into an output signal by using an electro-mechanical transducer and for reducing nonlinear total distortion in said output signal.

### BACKGROUND OF THE INVENTION

The invention generally relates to arrangements and a methods for identifying parameters of a nonlinear model, which describes the nonlinear vibration of mechanical structures, such as used in electro-mechanical and electro-acoustical transducers. This information is the basis for identifying the constructional causes of the nonlinearities, linearizing the transfer behaviors of those transducers and for compensating actively nonlinear signal distortion in an electrical, mechanical or acoustical output signal.

Loudspeakers and other electro-acoustical transducers use diaphragms, panels, shells and other mechanical structures to generate vibration and sound. At low frequencies the transducer can be modelled by a network comprising lumped elements because the major part of the sound radiating surface vibrates as a rigid body and only the suspension (e.g. spider and surround in a loudspeaker) is deformed. This model can also consider nonlinearities inherent in the mechanical suspension and motor of the transducer and is the basis for the measurement and control applications as described in the publication by Yeh, D.T., Bank, B. Karjalainen, M. entitled “Nonlinear Modeling of a Guitar Loudspeaker Cabinet” in Proceedings of 11th Int. Conference on Digital Audio Effects, pp. DAFx1-DAFx-8, September 2008 and in the patent application US 2005/0031139. The patent application US 2003/0142832 uses the nonlinear lumped parameter model to develop a recursive structure.

At higher frequencies the mechanical structure generates higher-order vibration modes which require more complex modeling using distributed parameters. The publication by Yeh, D.T. and the patent application US 2005/0175193 use linear systems (e.g. equalizers) for the simulation of the higher-order modes and the active correction of the loudspeaker's transfer behaviors at small amplitudes. However, the relationship between forces and displacement becomes nonlinear at higher amplitudes and additional spectral components (harmonic and intermodulation distortion) are generated. Those distortions impair the quality of the sound reproduced by audio devices and the performance of active noise reduction and echo cancelation.

Nonlinear vibration and the sound radiation of higher-order modes can be described by analytical or numerical models (BEM, FEM) which require detailed information on the geometry and the material used in the mechanical components.

N. Queagebeur and A. Chaigne suggest in the publication “Mechanical Resonances and Geometrical Nonlinearities in Electrodynamic Loudspeakers”, Journal of Audio Eng. Soc., Vol. 56, No. 6 (2008), 462-471 the Karman model to describes the mechanical system on a higher abstraction level. This model requires the natural functions (modal shapes), natural frequencies and modal loss factor of the higher-order modes which can be determined by scanning the movement of the surface of the mechanical structure.

Generic black box models have been used for describing the nonlinear transfer behavior without considering the physical causes of the signal distortion. The document U.S. Pat. No. 6,687,235, for example, uses the Volterra expansion for echo compensation. The documents U.S. Pat. No. 5,148,427, U.S. Pat. No. 8,509,125, US2013/0216056, U.S. Pat. No. 6,813,311 and U.S. Pat. No. 5,329,586 use instead static nonlinearities without memory, which can be realized as tables, power series or nonlinear hardware components.

### SUMMARY OF THE INVENTION

The invention discloses an arrangement and method for correcting the transfer behavior of an electro-mechanical or electro-acoustical transducer by improving the constructional design or by compensating the undesired signal distortion by an inverse nonlinear processing of the input or output signal. The invention is based on a physical model using distributed parameters which consider the nonlinear excitation of the higher-order modes, the influence of the time variant mode shapes on the sound radiation into the surrounding fluid (e.g. air).

The invention uses the physical information on the dominant nonlinearities to derive a block-oriented wave model which describes the generation of the nonlinear distortion and the transfer to the output signal.

The block oriented wave model distinguishes between activation modes, which activate the nonlinear behavior and affect the transfer modes, which transfer the input signal u into the output signal p. The amplitude response |Qₘ(f)| between the input signal u and the displacement of each mode of order m with 0<m≦M has a low-pass characteristic and falls with a slope of 12 dB per octave above its natural frequency fₘ due to the inertia of the moved mass distributed on the diaphragm. A second mode of order k which has a lower natural frequency (fₖ<fₘ) than the first mode of order m with m>k generates usually a higher amplitude |Qₖ(f)|>|Qₘ(f)| and activates the inherent nonlinearities to a larger extent. For this reason the fundamental and other low-order modes with 0<m≦M_{D} which contribute significantly to the displacement are considered as the activation modes.

All modes on the diaphragm with 0<m≦M may be considered as transfer modes. Higher-order modes m≧M_{D} with low displacement which cannot activate the nonlinearities may contribute to the generation of the sound pressure output p(rₐ) because the 2^{nd} derivative of the displacement (acceleration) determines the acoustical radiation.

The nonlinear interaction between the activation mode and transfer mode is modeled by a nonlinear processing of a modal activation signal qₘ representing the activation mode with a multi-modal signal w_{m,n} representing the transfer modes.

The modal activation signal qₘ is generated by a linear activation filter H_{e,m} representing at least one activation mode. The linear activation filter H_{e,m} has a transfer function Qₘ(f) with a low-pass characteristic where the poles generate an infinite impulse response.

The modal activation signal q₀ representing the fundamental mode of order m=0 with the lowest natural frequency f₀ can be generated by using lumped parameters Pₗ of a network model Nₗ. The series connection of the network model Nₗ followed by a block-oriented wave model N_{d} is an important feature of the invention.

The multi-modal signal w_{m,n} is generated by using a linear multi-modal filter with the transfer function H_{s,m,n}(s) representing nonlinear variation of the transfer behavior. The multi-modal filter has a broad-band transfer characteristic and considers the temporal variation of the excitation, the natural frequencies and mode shape of the transfer modes of order m with 0<m≦M and their influence on sound radiation.

The nonlinear processing of the multi-modal signal w_{m,n} and the modal activation signal qₘ can be realized by using a polynomial filter comprising quadratic, cubic and higher-order subsystem. Each power system of order n contains a static, nonlinear subsystem that generates a signal B_{m,n}=qₘ⁽ⁿ⁻¹⁾ which is the (n−1)th-order power of the modal activation signal qₘ. A source signal z_{m,n} is generated by multiplying the signal B_{m,n}=qₘ⁽ⁿ⁻¹⁾ with multi-modal signal w_{m,n}. The source signal z_{m,n} describes the distortion signal at the place (e.g. surround) and in the state variable (e.g. mechanical tension) where it is generated.

The source signal z_{m,n} is transferred via a following post filter with the transfer function H_{p,m,n}(s) into a virtual distortion contribution uₘ, which is added to the excitation signal u_{c} at the transducer's input and transferred via an additional linear filter with the transfer function Hₜₒₜ(s) to the output signal p(rₐ).

The free parameters of the activation filter, multi-modal transfer filter and post filter give the system-oriented wave model N_{d} the modeling capabilities to describe the influence of diaphragm's geometry and material properties, radiation condition, acoustical environment and other unknown processes. Thus the system-oriented wave model may be considered as a grey model providing sufficient degrees of freedom as other abstract, generic approaches (e.g. Volterra-system) while using structural information from physical modeling (e.g. FEM, BEM). It is a characteristic feature of the invention, that the system-oriented wave model N_{d} comprises a minimal number of free parameters P_{d}, which are interpretable in a mechanical and acoustical context and have a high diagnostic value for the development, optimization and quality control of transducers.

All free parameters P_{d} of the wave model N_{d} can be determined by adaptive system identification while exciting the transducer by an ordinary audio signal (e.g. music). Electrical signals measured at the transducer terminals can be used for the identification of the modal activation filter H_{e,0} of lowest order m=0 based on a network model Nₗ with lumped parameters Pₗ. The parameter identification of the modal activation filters H_{e,m} of higher order m>0 and of all multi-modal transfer filters H_{s,m,n} and post filters H_{p,m,n} require a mechanical or acoustical sensor.

The wave model N_{d} can be used to synthesize signal distortions in the transducer input signal which compensate actively for the nonlinear distortion generated by the transducers and linearize the overall transfer behavior. Active distortion reduction can improve the performance of echo cancellation in telecommunication applications using the microphone signal p(rₛ) for the identification of the nonlinear parameters.

The linearization of the acoustical output of the transducer requires a nonlinear preprocessing of the input signal v in a control system and the generation of a control output signal u used for the excitation of the transducer. The control system proposed by the invention comprises two subsystems connected in series using a priori information provided by physical modeling. The first subsystem generates compensation distortion v_{d} by using the structure and parameters of the wave model N_{d} and subtracts the distortion v_{d} from the input signal v. The difference signal v−v_{d} is supplied to the input of the second subsystem, which generates distortion vₗ based on information of the network model Nₗ and the control output signal u=v−v_{d}−vₗ by subtracting the distortion vₗ from the output of the first subsystem.

These and other features, benefits and technical feasibility of the present invention are characterized more by the following illustrations, detailed description and claims.

### BRIEF DESCRIPTION OF THE DRAWINGS

FIG. 1 shows a nonlinear model of the modal vibration and sound radiation of a transducer based on constant modal shape ψ₀.

FIG. 2 shows the geometry (dashed line) at rest position and the maximum positive and negative displacement (solid lines) of the diaphragm for a sinusoidal excitation at 10 kHz.

FIG. 3 shows the geometry (dashed line) of the diaphragm by generating −0.3 mm negative DC displacement of the voice coil and the maximum positive and negative displacement (solid lines) of the diaphragm for a sinusoidal excitation at 10 kHz.

FIG. 4 shows the geometry (dashed line) of the diaphragm by generating 0.3 mm positive DC displacement of the voice coil and the maximum positive and negative displacement (solid lines) of the diaphragm for a sinusoidal excitation at 10 kHz.

FIG. 5 shows the variation of the effective radiation area S_{d}(x_{dc}) as a function of the static displacement x_{dc} of the voice coil.

FIG. 6 shows a nonlinear model of the modal vibration and sound radiation of a transducer considering the change of the modal shape ψ(Q).

FIG. 7 shows the amplitude response of the modal displacement versus frequency.

FIG. 8 shows a nonlinear system modeling the modal vibration and sound radiation of the transducer by using equivalent input distortion uₗ and u_{d}.

FIG. 9 shows a modified nonlinear model system modeling the modal vibration and sound radiation of the transducer by using equivalent input distortion uₗ and u_{d}.

FIG. 10 shows an embodiment of the nonlinear System N_{d} generating the nonlinear equivalent input distortion u_{d}.

FIG. 11 shows an embodiment of the nonlinear connection element generating a distortion contribution u_{m,n}.

FIG. 12 shows an embodiment of the invention to identify the parameters Pₗ, P_{d} and Pₜₒₜ.

FIG. 13 shows a first embodiment of the invention to linearize the measured signal pₒᵤₜ.

FIG. 14 shows a second embodiment of the invention to linearize the measured signal pₒᵤₜ.

FIG. 15 shows an embodiment of the invention to linearize the transducer output signal p(rₐ).

### DETAILED DESCRIPTION OF THE INVENTION

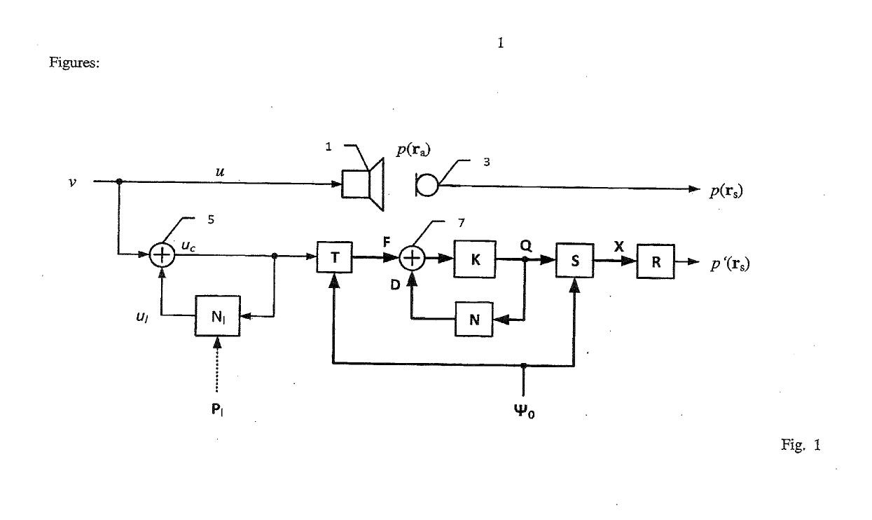

FIG. 1 shows a first system model describing the transfer behavior of transducer 1 between the electrical input signal v and the sound pressure output signal p(rₛ) measured by an acoustical sensor 3 at measurement point rₛ. The nonlinear network model Nₗ describes the effect of nonlinearities inherent in the motor and in the mechanical suspension of transducer 1 by using lumped parameters Pₗ and generates a distortion signal uₗ. The adder 5 generates based on the input signal u and distortion signal uₗ the distorted input signal u_{c}=u+uₗ. A modal transformation system T generates based on the distorted input signal u_{c} the excitation forces:

$${F}_{m} = {u}_{c} * {L}^{- 1} \{ \frac{Bl}{{R}_{e} + {L}_{e} s} \} {γ}_{m} ( {Ψ}_{m} ( {r}_{coil} ) ) m = 0 , … , M \qquad ( 1 )$$

The forces summarized in vector F=[F₀, . . . , Fₘ, . . . , F_{M}] are generated by the convolution represented by operator * of the distorted input signal u_{c} with the inverse Laplace-transformation L⁻¹{ } of the rational transfer function, comprising force factor Bl, voice coil resistance Rₑ, inductance Lₑ and Laplace operator. The excitation function γₘ depends on the mode shapes ψ₀=[ψ₀, . . . , ψₘ, . . . , ψₘ] at point r_{coil}, where the voice coil excites the diaphragm to mechanical vibration.

The displacement x(r,t) at any point r on the diaphragm is described by a modal expansion

$$x ( r , t ) = {\sum }_{m = 0}^{M} {Ψ}_{m} ( r ) {q}_{m} ( t ) \qquad ( 2 )$$

using the modal shapes in vector ψ₀ and the modal displacements in vector Q=[(q₀, . . . , qₘ, . . . , q_{M}]. The mode shapes ψ₀ are according to the state of the art (see Quaegebeur) independent of the modal displacements Q.

An adder 7 generates based on excitation F and the modal distortion forces D=[D₀, . . . , Dₘ, . . . , D_{M}] the total forces which are transformed via a linear transfer element K into the modal displacement

qₘ=(Fₘ+Dₘ(Q))*L⁻¹{Kₘ(s)}m=0, . . . ,M (3)

by convoluting the total forces F+D with the impulse response of the modal transfer function

$${K}_{m} ( s ) = \frac{1}{1 + {η}_{m} \frac{s}{{ω}_{m}} + {( \frac{s}{{ω}_{m}} )}^{2}} {G}_{in} ( s ) \qquad ( 4 )$$

using the inverse Laplace transform.

The modal transfer function Kₘ(s) describes the linear dynamics of the vibration modes with the modal loss factor ηₘ and natural frequency ωₘ. The additional transfer function Gᵢₙ(s) considers the influence of a coupled mechanical or acoustical systems. A vent in a loudspeaker enclosure, for example, generates at the acoustical Helmholtz resonance frequency fₚ a null in the transfer function Gᵢₙ(s), without changing the mode shapes in ψ₀.

The nonlinear distortion forces

$${D}_{m} ( Q ) = {\sum }_{i = 0}^{M} {\sum }_{j = 0}^{M} {a}_{m , i , j} {q}_{i} {q}_{j} + {\sum }_{i = 0}^{M} {\sum }_{j = 0}^{M} {\sum }_{k = 0}^{M} {a}_{m , i , j , k} {q}_{i} {q}_{j} {q}_{k} + … \qquad ( 5 )$$

are expanded by the static nonlinear system N into a power series of modal displacements qᵢ from vector Q. The coefficients a_{m,i,j, . . .} represent the nonlinear bending stiffness of the diaphragm.

The inverse modal transformation S generates based on the modal displacements Q and mode shapes ψ₀ according to Eq. (2) the displacements X=[x(r₁), . . . , x(rₖ), . . . , x(r_{K})] at any point on the sound radiating surface. The following radiation system R generates based on the displacements X the sound pressure p′(rₐ,t) at the observation point rₐ by using the Rayleigh integral

$${p}^{′} ( {r}_{a} , t ) = \frac{{ρ}_{0}}{2 π} {\int }_{{S}_{e}} x ( r , t ) * {L}^{- 1} \{ {s}^{2} G ( s , {r}_{a} \vert r ) \} d {S}_{c} \qquad ( 6 )$$

with the Green's function

$$G ( s , {r}_{a} \vert r ) = \frac{exp ( \vert r - {r}_{a} \vert s \text{/} {c}_{0} )}{\vert r - {r}_{a} \vert} , \qquad ( 7 )$$

density of air ρ₀ and the sound radiating surface S_{c}.

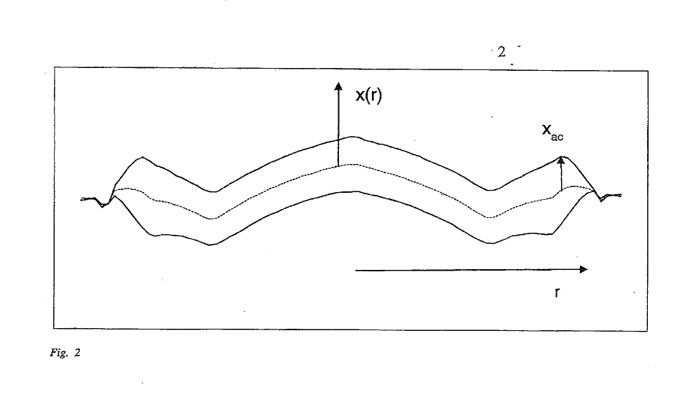

FIG. 2 shows, for example, the geometry of a diaphragm used in headphones as a dashed line and the positive and negative maximum displacement x_{ac}, for a sinusoidal excitation at 10 kHz.

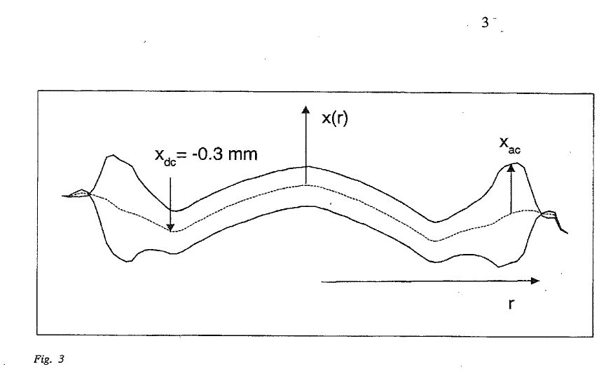

FIG. 3 shows the influence of a negative DC signal x_{dc}=−0.3 mm on the mode shape at 10 kHz. The DC signal represents a low frequency tone (bass tone) generating high displacement in the fundamental mode m=0 which effects the mode shape ψₘ of the higher-order modes (m≧0) and generates the vibration at the outer region of the diaphragm.

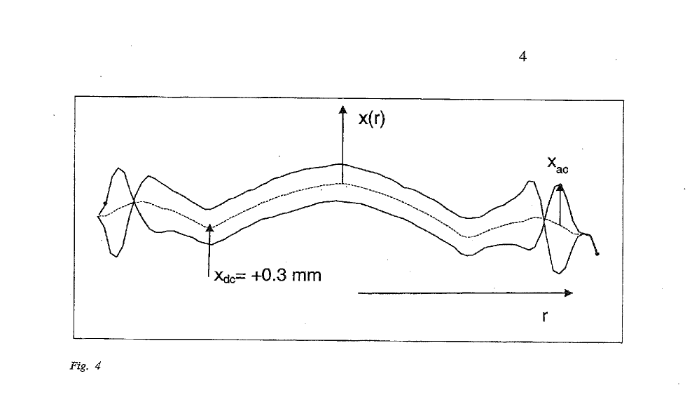

FIG. 4 shows the influence of a positive DC signal x_{dc}=0.3 mm generating nodes in the mode shape dividing the diaphragm into an inner and outer region which are vibrating in anti-phase. The Rayleigh integral in Eq. (6) accumulates destructively the positive and negative volume velocities generating a reduced acoustical output compared to the modal shape depicted in FIG. 3. The nonlinear dependency of the mode shapes ψ(Q) on the modal displacements Q may be also described by the effective radiation area defined as

$${S}_{D} ( s ) = \frac{{\int }_{{S}_{c}} X ( s , r ) d {S}_{c}}{\overline{{X}_{coil}} ( s )} , \qquad ( 8 )$$

using the mean voice coil displacement

$$\overline{{X}_{coil}} ( s ) = \frac{{\int }_{{ }_{{r}_{coil}}} X ( s , r ) d r}{{\int }_{{ }_{{r}_{coil}}} d r} . \qquad ( 9 )$$

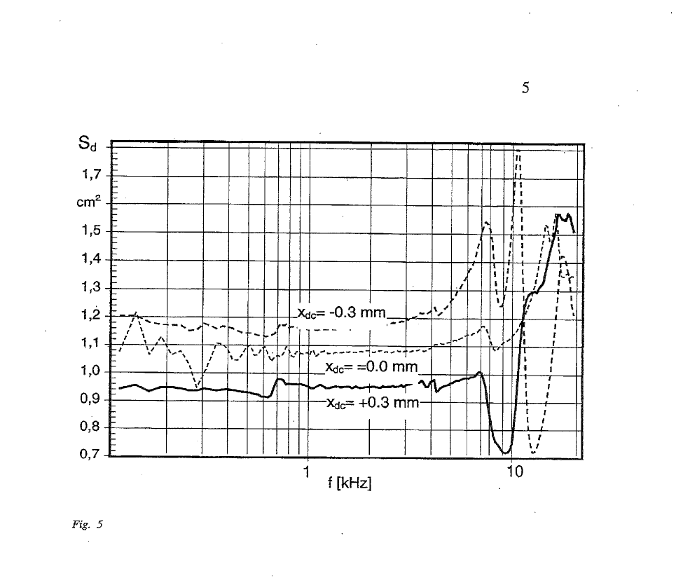

FIG. 5 shows the effective radiation area S_{d}(x_{dc},f) of the headphone diaphragm as a function of the static displacement x_{d}, generated by the DC signal and the frequency f of the AC excitation tone. The effective radiation area S_{d}(x_{dc},f) decreases 30% by shifting the voice coil in positive direction and increases more than 50% in negative direction at 10 kHz. Below 5 kHz the varying DC signal generates about 10% variation of the effective radiation area S_{d}(x_{dc},f).

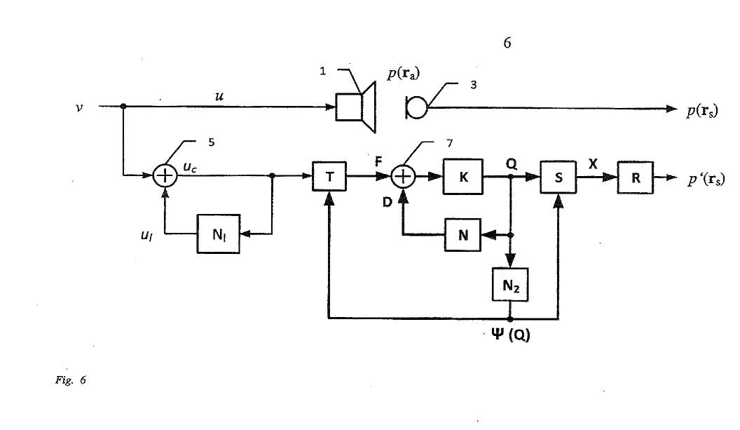

FIG. 6 shows an extended model of the transducer in accordance with the invention by using the modal expansion

$$x ( r , t ) = {\sum }_{m = 0}^{M} {Ψ}_{m} ( r , Q ) {q}_{m} ( t ) \qquad ( 10 )$$

which considers the nonlinear dependency of the mode shapes ψ(r, Q) on the displacements Q in a static nonlinear system N₂ which can be described as a power series:

$$( 11 )$$

$${Ψ}_{m} ( r , Q ) = {Ψ}_{m} ( r , 0 ) ( 1 + {\sum }_{i = 0}^{M} {b}_{m , i} ( r ) {q}_{i} + {\sum }_{i = 0}^{M} {\sum }_{j = 0}^{M} {b}_{m , i , j} ( r ) {q}_{i} {q}_{j} + … )$$

The time varying mode shapes ψ(r, Q) are used in modal transformation T generating the excitation forces

$${F}_{m} = {u}_{c} * {L}^{- 1} \{ \frac{Bl}{{R}_{e} + {L}_{e} s} \} {γ}_{m} ( {Ψ}_{m} ( {r}_{coil} , Q ) ) m = 0 , … , M , \qquad ( 12 )$$

by using the series expansion

$${γ}_{m} ( {Ψ}_{m} ( {r}_{coil} , Q ) ) = {γ}_{m} Ψ ( {Φ}_{m} ( {r}_{coil} , 0 ) ) ( 1 + {\sum }_{i = 0}^{M} {c}_{m , i} ( r ) {q}_{i} + {\sum }_{i = 0}^{M} {\sum }_{j = 0}^{M} {c}_{m , i , j} ( r ) {q}_{i} {q}_{j} + … ) \qquad ( 13 )$$

of the modal displacements Q.

The extended model in FIG. 6 has a high complexity and a large number of free parameters a_{m,i,j, . . .} , b_{m,i, . . .} and c_{m,i, . . .} , which have to be identified for the particular transducer at sufficient accuracy. The computational effort can be significantly reduced by applying a useful approximation to the power series in Eqs. (5), (11) and (13) and neglecting cross terms of the modal displacements qᵢ which do not contribute significantly to the total distortion.

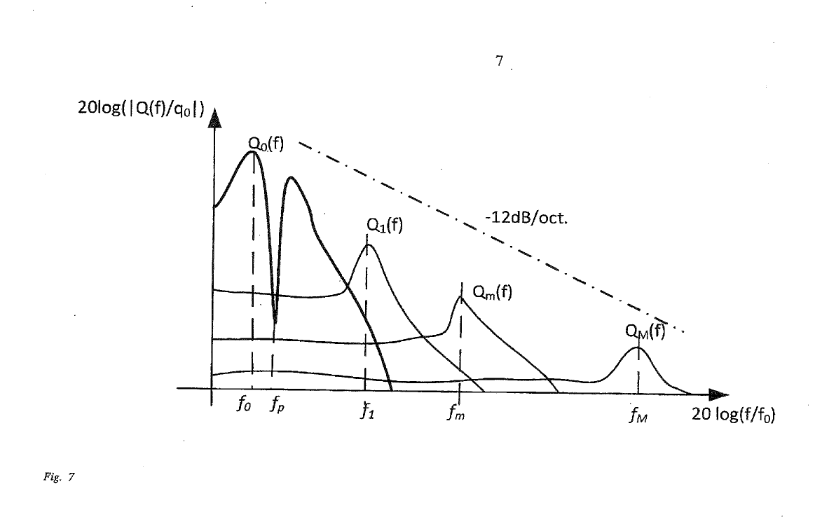

According to Eq. (4) all modes have a low-pass characteristic generating the amplitude response |Qₘ(f)| of the modal displacement of order m=0, 1, . . . as shown in FIG. 7. The fundamental mode (m=0) with the lowest natural frequency f₀ generates the largest displacement q₀ besides the acoustical resonance frequency fₚ where the vented box enclosure causes a null in the transfer function. The higher-order modes (m>0) generate at the natural frequency fₘ the highest amplitude due to the low losses usually found in diaphragm materials. At all other frequencies the amplitude |Qₘ(f)| of the higher-order modes is smaller than the amplitude |Qₖ(f)| generated by lower-order modes (with k<m) below the natural frequency f≦fₖ giving the following relationship between the nonlinear terms in the power expansion:

|Qₘ(fₘ)|ⁿ>|Qₖ(fₖ)|ⁿ>|Qₘ(fₘ)|ⁿ⁻ⁱ|Qₖ(fₖ)|ⁱm<k,i=1, . . . ,n−1 (14)

This relationship can be used to select the dominant nonlinear terms in Eqs. (5), (11) and (13) and generating a useful approximation for the distortion forces

$$\begin{matrix}{D}_{m} ( Q ) \approx {q}_{m} {\sum }_{i = 0}^{{M}_{D}} ( {a}_{m , m , i} {q}_{i} + {a}_{m , m , i , i} {q}_{i}^{2} + … ) \\ = {q}_{m} {\sum }_{i = 0}^{{M}_{D}} {\sum }_{n = 2}^{N} {α}_{m , i , n} {q}_{i}^{n - 1}\end{matrix} \qquad ( 15 )$$

the nonlinear variation of the mode shape

$$\begin{matrix}{Ψ}_{m} ( r , Q ) \approx {Ψ}_{m} ( r , 0 ) ( 1 + {\sum }_{i = 0}^{{M}_{D}} ( {b}_{m , i} ( r ) {q}_{i} + {b}_{m , i , i} ( r ) {q}_{i}^{2} + … ) ) \\ = {Ψ}_{m} ( r , 0 ) ( 1 + {\sum }_{i = 0}^{{M}_{D}} {\sum }_{n = 2}^{N} {β}_{m , i , n} ( r ) {q}_{i}^{n - 1} )\end{matrix} \qquad ( 16 )$$

and the nonlinear excitation function

$${γ}_{m} ( {Ψ}_{m} ( {r}_{coil} , Q ) ) \approx {γ}_{m} ( {Ψ}_{m} ( {r}_{coil} , 0 ) ) ( 1 + {\sum }_{i = 0}^{{M}_{D}} {\sum }_{n = 2}^{N} {χ}_{m , i , n} ( r ) {q}_{i}^{n - 1} ) . \qquad ( 17 )$$

The Eqs. (15), (16) and (17) reveal a nonlinear interaction between modes of different order generating intermodulation distortion between low and high frequency components. In practice the displacement q₀ of the fundamental mode (m=0) with the lowest natural frequency f₀ activates the dominant nonlinearities of the wave model N_{d}.

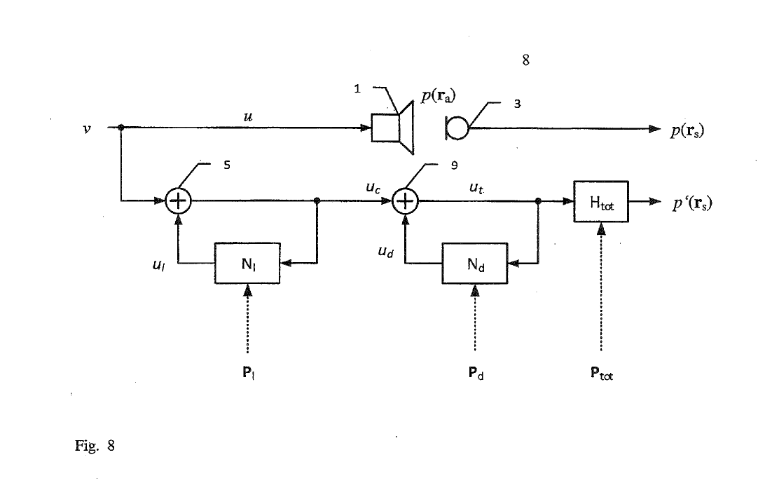

FIG. 8 shows a nonlinear model of the mechanical vibration and sound radiation by using a system oriented approach where the nonlinear distortion generated in the mechanical and acoustical domain are transformed into an equivalent input distortion signal u_{d} which is combined with the output signal u_{c} output of network model Nₗ by adder 9. The total signal u_{c}+u_{d} is transferred via a linear filter with the transfer function Hₜₒₜ(s) into the acoustical output signal:

$$\begin{matrix}{p}^{′} ( t , {r}_{a} ) = {u}_{t} * {L}^{- 1} \{ {H}_{tot} ( s ) \} \\ = ( {u}_{c} + {u}_{d} ) * {L}^{- 1} \{ {H}_{tot} ( s ) \}\end{matrix} \qquad ( 18 )$$

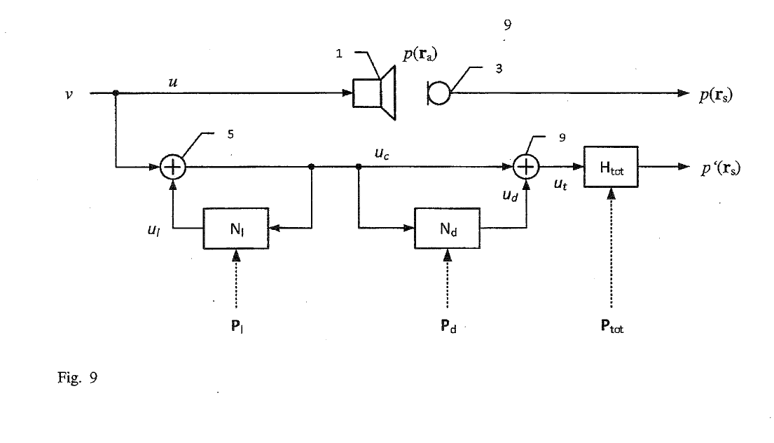

FIG. 9 shows an alternative embodiment of the invention. Contrary to FIG. 8, the input of the nonlinear system N_{d} is not supplied with the total signal uₜ from the output of adder 9 but receives the input signal u_{c}. This feed-forward approximation simplifies the realization with adaptive FIR filters which are stable for all values of the filter parameters.

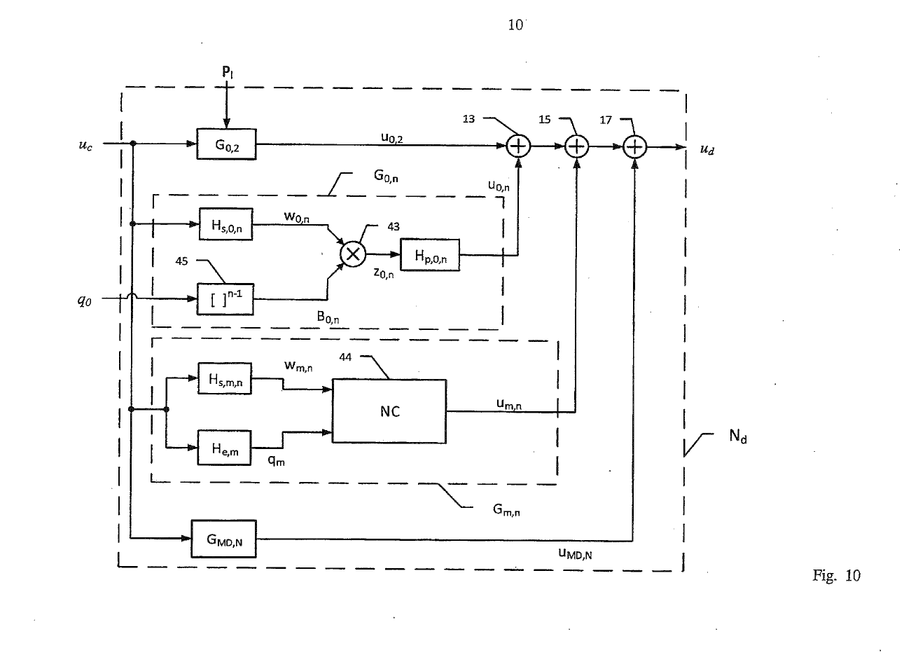

FIG. 10 shows an embodiment of the nonlinear systems N_{D}, which generates the multi-modal distortion signal u_{d}. This system comprises a multitude of nonlinear subsystems G_{m,n} with m=0, . . . , M_{D} and n=2, . . . , N connected in parallel, each generating based on the input signal u_{c} a distortion contribution

u_{m,n}=((L⁻¹{H_{e,m}(s)}*u_{c})ⁿ⁻¹(L⁻¹{H_{s,m,n}(s)}*u_{c}))*L⁻¹{H_{p,m,n}(s)} (19)

summarized by adders 13, 15, 17 to the multi-modal distortion:

$${u}_{d} = {\sum }_{m = 0}^{{M}_{D}} {\sum }_{n = 2}^{N} {u}_{m , n} \qquad ( 20 )$$

The subsystem G_{m,n} comprises a linear modal activation filter H_{e,m} generating based on input signal u_{c} a modal activation signal qₘ, describing the state of at least one dominant mechanical vibration mode. The modal activation filter H_{e,m} has poles in the rational transfer function H_{e,m}(s) and generates an infinite impulse response, like a recursive IIR-Filter. A linear multi-modal transfer filter H_{s,m,n} generates based on input signal u_{c} a multi-modal signal w_{m,n}, which represents the effect of the all mechanical modes (0≦m≦M) on the mechanical vibration and the sound radiation at the surface S_{c}. Thus, the multi-modal signal w_{m,n} describes the transfer of the linear audio signal by the mechanical and acoustical system and the scaling with nonlinear coefficients a_{m,i,n}, β_{m,i,n} and χ_{m,i,n} in the power series expansion in Eqs. (15), (16) and (17). The Rayleigh integral in Eq. (6) may generate nulls in the linear multi-modal transfer filter H_{s,m,n} and can be embodied by an FIR-filter.

The connection element 44 combines the multi-modal signal w_{m,n} with the modal activation signal qₘ based on a nonlinear transfer function and generates the distortion contribution u_{m,n}.

The subsystem G_{0,2} in FIG. 10 has a similar structure as the subsystem G_{m,n}, but uses the lumped parameters Pₗ provided by nonlinear network model Nₗ in FIG. 1 to generate the modal activation signal qₘ based on the input signal u_{c} in the first modal activation filter H_{e,0} with the transfer function:

$${H}_{e , 0} ( s ) = {K}_{0} ( s ) \frac{Bl}{{R}_{e} + {L}_{e} s} \qquad ( 21 )$$

The subsystem G_{0,n} in FIG. 10 shows a further embodiment, which dispenses with the first linear Filter H_{e,0} but receives the modal activation signal qₘ directly from the network model or from another external source. The static nonlinearity 45, the multiplier 43 and the post filter H_{p,0,n} are an embodiment of the connection element 44.

The multi-modal transfer functions of the quadratic subsystem (m=0, n=2)

$${H}_{s , 0 , 2} ( s ) = \frac{{S}_{D} ( s , {x}_{d c} ) - {S}_{D} ( s , - {x}_{d c} )}{2 {x}_{d c} {S}_{D} ( s , 0 )} \qquad ( 22 )$$

and of the cubic subsystem (m=0, n=3)

$${H}_{s , 0 , 3} ( s ) = \frac{{S}_{D} ( s , {x}_{d c} ) + {S}_{D} ( s , - {x}_{d c} ) - 2 {S}_{D} ( s , 0 )}{{x}_{d c}^{2} {S}_{D} ( s , 0 )} \qquad ( 23 )$$

can be calculated by using the effective radiation area S_{d}(x_{dc}) of the headphone diaphragm as shown in FIG. 5 based on the assumption that the transfer function of the post filter

H_{p,0,n}(s)=1n=2,3 (24)

is assumed as constant over frequency.

The linear parameters Pₜₒₜ describe the total transfer function Hₜₒₜ(s)

$${H}_{tot} ( s ) = \frac{{ρ}_{0}}{2 π} \frac{\overline{{X}_{coil}} ( s )}{U ( s )} {s}^{2} {S}_{D} ( s , 0 ) G ( s , {r}_{a} \vert {r}_{coil} ) , \qquad ( 25 )$$

using the effective radiation area S_{D}(s,0) at the rest position x_{dc}=0, the linear lumped parameters Pₗ of the network model and the Green's function G.

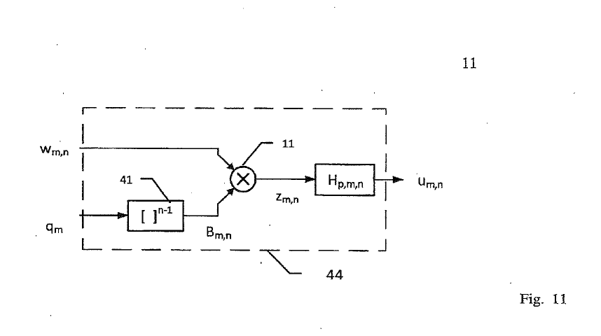

FIG. 11 shows an embodiment of the connection element 44. A static nonlinearity 41 sets the modal activation signal qₘ to the (n−1)th power. The output signal B_{m,n}=qₘ⁽ⁿ⁻¹⁾ is combined with the multi-modal signal w_{m,n} in multiplier 11 and the generated source signal z_{m,n} is transferred via a post filter H_{p,m,n} into the distortion contribution u_{m,n}. The post filter considers the position of the nonlinear distortion source on the diaphragm, the local excitation point of the modal vibration and the radiation condition and distance |r−rₐ| in the Green's function in Eq. (7).

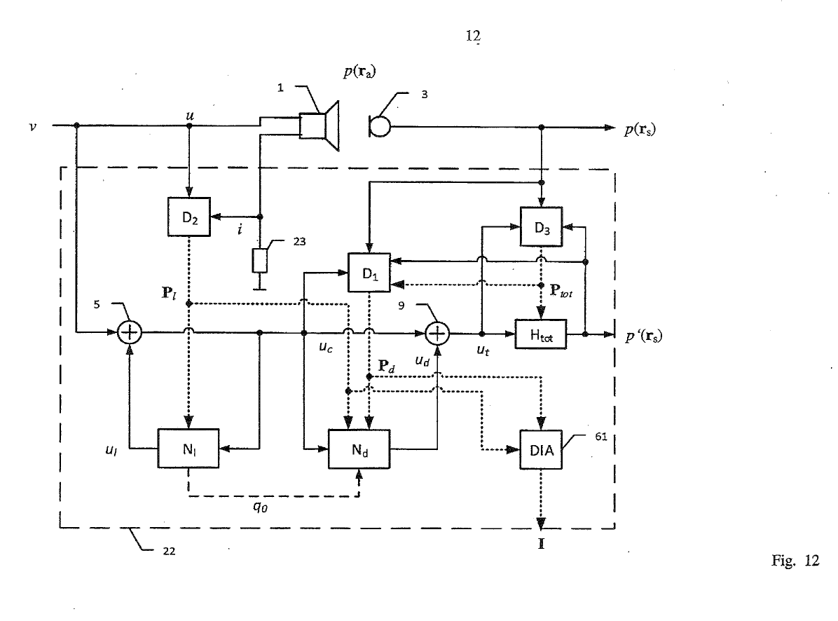

FIG. 12 shows an embodiment of the invention used for the identification of the free model parameters Pₗ, P_{d} and Pₜₒₜ. The lumped parameters Pₗ are determined by a second parameter detector D₂ based on the terminal voltage u and input current i of transducer 1 measured by using a current sensor 23. The lumped parameters Pₗ are supplied to the nonlinear network model Nₗ, to the wave model N_{d} and to a diagnostic system 61.

The distributed parameters P_{d} are generated in a first parameter detector D₁ by using a sensor signal p(rₛ) provided by an acoustical or mechanical sensor 3, the estimated signal p′(rₛ) generated at the output of the linear filter Hₜₒₜ and the electrical output signal u_{c} of adder 5. The first parameter detector D₁ may be embodied as an adaptive system, identifying the coefficients of the linear FIR-filter H_{s,0,n} and H_{p,m,n} in the wave model N_{d} as disclosed in the patent application GB 2308898. The unique identification of the poles in the IIR filters H_{e,m} with m=0, . . . , M_{d}−1 requires a constraint on the natural frequencies fₘ<fₘ₊₁ represented by each IIR filter. The wave model N_{d} may use a state signal q₀ generated by network model Nₗ describing the mechanical mode m=0 with the lowest natural frequency f₀.

The linear parameters Pₜₒₜ of the linear total system Hₜₒₜ are determined by the third parameter detector D₃ based on the sensor signal p(rₛ), the estimated signal p′(rₛ) and the total signal uₜ. The diagnostic system 61 generates information I, which simplify the interpretation of the model parameters Pₗ and P_{d} and reveal the physical root cause of the signal distortion generated by transducer 1. For example, the nonlinear dependency of the effective radiation area S_{D}(f,x_{dC}) on frequency f and DC displacement x_{dC} can be calculated based on the transfer functions H_{s,0,2}(s) and H_{s,0,3}(s) in accordance with Eqs. (22) and (23).

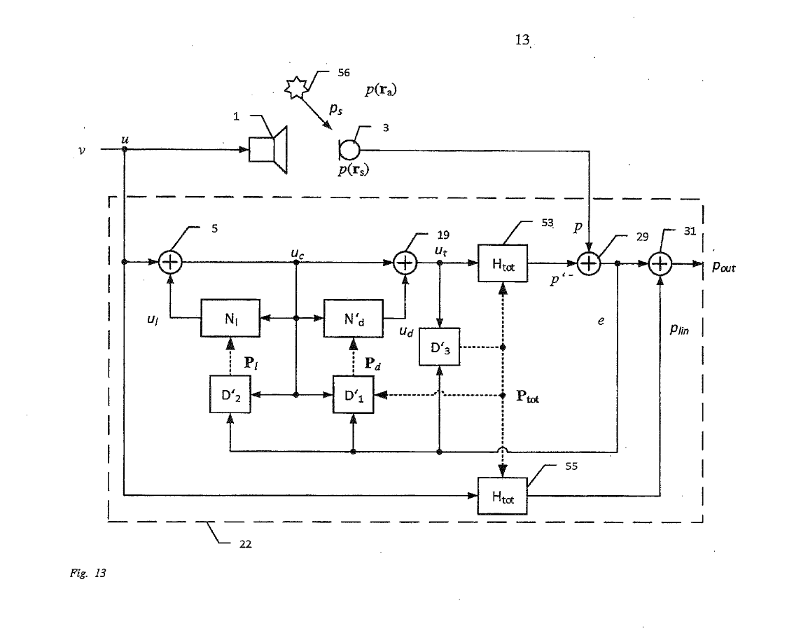

FIG. 13 shows a first embodiment of the active distortion compensation in the measured sound pressure signal p(rₛ) generating a linearized output signal pₒᵤₜ. This arrangement uses a subtraction element 29 to generate an error signal e=p(rₛ)−p′(rₛ) as the difference between the measured and the modelled sensor signal. This parameter detectors D′₁, D′₂ and D′₃ generate adaptively optimal estimates of parameters Pₗ, P_{d} and Pₜₒₜ by minimizing the error signal e. After convergence of the adaptive process the error signal e contains the external signal pₛ generated by an additional signal source 56, measurement noise and other disturbances, which cannot be compensated by the model. A linear model system 55 having the same transfer function Hₜₒₜ(s) as the linear model 53 generates based on linear parameters Pₜₒₜ a linear output signal pₗᵢₙ. An adder 31 generates based on linear signal Pₗᵢₙ and error signal e the linearized output signal pₒᵤₜ. The error signal e(t)≈pₛ(t) and the linearized output signal pₒᵤₜ(t) may be used for echo compensation in telecommunication and other applications.

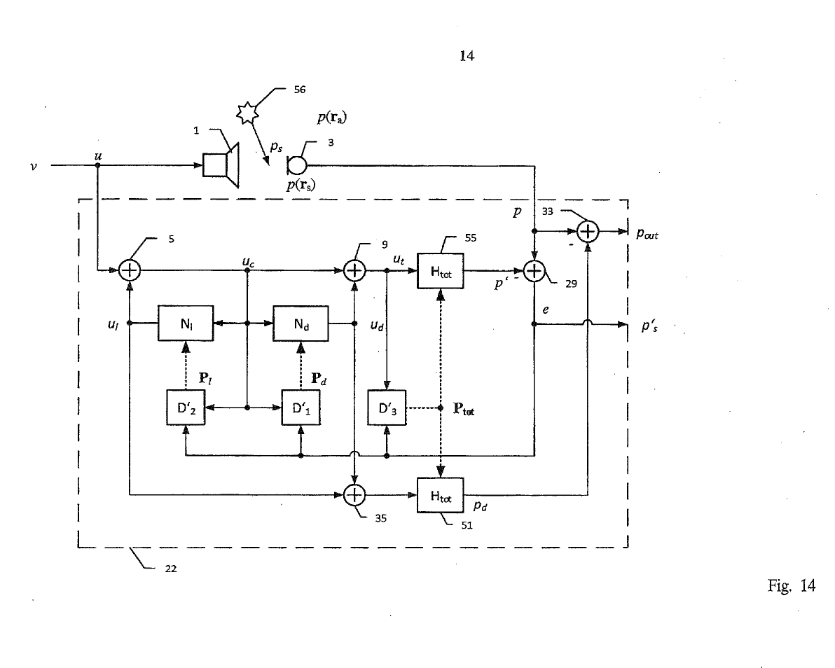

FIG. 14 shows an alternative embodiment of the active distortion compensation of the linearized output signal pₒᵤₜ. The distortion signals uₗ and u_{d} at the outputs of the network model Nₗ and wave model N_{d}, respectively, are added by element 35 and transferred via a linear filter 51 with transfer function Hₜₒₜ(s) into the total distortion p_{d}. A subtraction element 33 generates the linearized output signal pₒᵤₜ(rₛ)=p(rₛ)−p_{d} based on the sensor signal p(rₛ) and the total distortion p_{d}.

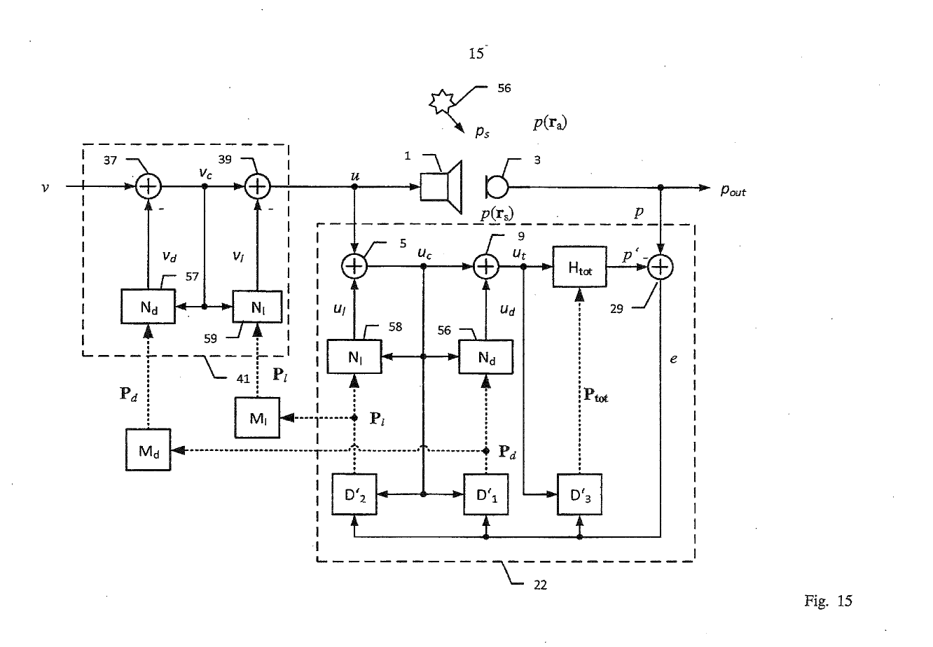

FIG. 15 shows an embodiment of the inverse preprocessing of des input signal v and the generation of a pre-distorted excitation signal u=v−v_{d}−vₗ based on distributed parameters P_{d} and the lumped parameters Pₗ in accordance with the invention. The control system 41 comprises a first nonlinear synthesis element 59, corresponding to the network model Nₗ and the lumped parameters Pₗ used in the nonlinear element 58 of the adaptive identification system 22. The state variables v_{c} and u_{c} at the input of elements 59 and 58, respectively, are identical because the distortion signals uₗ and vₗ are compensated by the subtraction element 39 and adder 5.

The control system 41 contains a second nonlinear synthesis system 57, corresponding to the wave model N_{d} and the distributed parameters P_{d} used in nonlinear system 56 of the identification system 22 as shown in FIG. 10. Since the synthesized distortion signal v_{d} equals the modelled distortion signal u_{d}, both distortions are cancelled by the subtraction element 37 and adder 9 and the input signal v corresponds to the total signal uₜ and a linear transfer behavior is generated between input signal v and the sound pressure p(rₐ) at an arbitrary observation point rₐ in the sound field.

The lumped parameters Pₗ and the distributed parameters P_{d} are valid for an arbitrary input signal v for limited period of time. Thus the identification system 22 may be temporarily deactivated and the control system 41 may be provided by parameters P_{d} and Pₗ stored in the memory elements M_{d} and Mₗ, respectively. However, the identification system 22 has to be activated for generating initial starting values for the parameters Pₗ and P_{d} and compensating aging, fatigue in transducer (1) and other external influences.

### Advantages of the Invention

The invention uses physical modeling to develop a general model which requires no detailed information on the design of the transducers, in particular the shape and the properties of the material used in the diaphragm or other mechanical structures generating vibration or sound. Limiting the maximum order N of the power series expansion and the maximum order M_{D} of vibration modes the model can be used to compensate dominant nonlinearities only and to achieve sufficient performance in the distortion reduction at low processing load and cost.

The arrangements and methods used for parameter identification and distortion reduction behave stable under all conditions and provide valuable information about the transducer parameters and internal state variables, which can be used for root cause analysis of signal distortion and further optimization of the transducer design.

Contrary to the known physical models as proposed by Queagebeur there is no need for a scanning sensor to measure the modal shape of mechanical vibration or sound pressure distribution. The mechanical or acoustical sensor already required for active echo compensation, active vibrations- and noise control can also be used for the current invention reducing the cost for additional hardware components.

The invention can be implemented in available microprocessors or digital signal processors (DSP) at low memory requirements and processing load. The lumped parameters Pₗ and distributed parameters P_{d} can be identified adaptively while exciting the transducer with an arbitrary audio signal (e.g. music). The adaptive identification system 22 can be deactivated temporarily, if the transducer and other hardware components behave sufficiently time invariant during this period.

1. Arrangement for converting an input signal v into an output signal p(rₐ) by using an electro-mechanical transducer and for reducing nonlinear total distortion p_{d} in said output signal p(rₐ), whereas the nonlinear total distortion p_{d} contains multi-modal distortions u_{d} which are generated by nonlinear partial vibration of mechanical transducer components, the arrangement comprising:
a sensor which is configured and arranged such to measure a mechanical or an acoustical state variable (p(rₛ)) of said transducer and to generate a measurement signal p based on said measured state variable (p(rₛ));
a first parameter detector (D₁; D′₁) which is configured and arranged such to generate based on said measurement signal p distributed parameters P_{d}, whereas
the distributed parameters P_{d} contain modal information H_{e,m}(s) of at least one activation mode, which activates the nonlinear partial vibration of the mechanical component;
the distributed parameters P_{d} contain multi-modal information H_{s,m,n}(s), which describe the nonlinear influence of the activation mode on transfer modes, whereas the transfer modes generate the output signal p(rₐ);
a nonlinear wave model, which is configured and arranged such to generate based on said input signal v and said distributed parameters P_{d} multi-modal distortion u_{d}, whereas the nonlinear wave model comprises
an activation filter (H_{e,m}) which is configured and arranged such to generate based on the modal information H_{e,m}(s) a modal activation signal qₘ, which describes the vibration state of said activation mode;
a transfer filter (H_{s,m,n}) which is configured and arranged such to generate based on the multi-modal information H_{s,m,n}(s) a multi-modal signal w_{m,n}, which describes the nonlinear relationship between the modal activation signal qₘ and the multi-modal distortion u_{d}; and
a nonlinear connection element which is configured and arranged such to combine the modal activation signal qₘ and multi-modal signal w_{m,n} and to generate a distortion contribution u_{m,n} for said multi-modal distortion u_{d}.

2. Arrangement for converting an input signal v into an output signal p(rₐ) by using an electro-mechanical transducer and for reducing nonlinear total distortion p_{d} in said output signal p(rₐ), whereas the nonlinear total distortion p_{d} contains multi-modal distortions u_{d} which are generated by nonlinear partial vibration of mechanical transducer components, the arrangement comprising:
a multi-modal synthesizing element which is configured and arranged such to generate based on the input signal v a multi-modal compensation signal v_{d} by using a nonlinear wave model (N_{d}) and distributed parameters P_{d}, whereas
the multi-modal compensation signal v_{d} describes the multi-modal distortion u_{d};
said distributed parameters P_{d} comprise modal information H_{e,m}(s) of at least one activation mode, which activates the nonlinear partial vibration of the mechanical component;
die distributed parameters P_{d} comprise multi-modal information H_{s,m,n}(s) which describe the nonlinear influence of the activation mode on transfer modes, whereas the transfer modes generate the output signal p(rₐ);
the wave model comprises at least one activation filter (H_{e,m}), which is configured and arranged such to generate based on the modal information H_{e,m}(S) a modal activation signal qₘ, which describes the vibration state of said activation mode;
the wave model comprises at least one transfer filter (H_{s,m,n}), which is configured and arranged such to generate based on the multi-modal information H_{s,m,n}(s) a multi-modal signal w_{m,n}, which describes the nonlinear relationship between the modal activation signal qₘ and the multi-modal distortion u_{d};
the wave model comprises at least one nonlinear connection element which is configured and arranged such to combine the modal activation signal qₘ and multi-modal signal w_{m,n} and to generate a distortion contribution u_{m,n} for the multi-modal compensation signal v_{d}; and
a first subtraction element which is configured and arranged such to generate a control signal v_{c} based on the difference of said input signal v and said multi-modal compensation signal v_{d} and to supply the generated control signal v_{c} to the transducer.

3. Arrangement according to claim 1, whereas
said activation filter (H_{e,m}) comprises a linear transfer behavior with a low-pass characteristic, whereas the low-pass characteristic is determined by said modal information H_{e,m}(s);
the transfer filter (H_{s,m,n}) comprises linear transfer behavior with a high-pass characteristic, whereas the high-pass characteristic is determined by said multi-modal information H_{s,m,n}(s); and
said nonlinear connection element comprises
a homogenous nonlinear power system, which is configured and arranged such to set said modal activation signal qₘ to the power with the exponent n−1 and to generate a powered signal B_{m,n}=qₘⁿ⁻¹;
a multiplicator (11), which is configured and arranged such to generate a nonlinear source signal z_{m,n} based on a multiplication of the powered signal B_{m,n} with said multi-modal signal w_{m,n}; and
a linear post filter (H_{p,m,n}), which is configured and arranged such to transfer the nonlinear source signal z_{m,n} into a distortion contribution u_{m,n}, whereas the distributed parameters P_{d} determine the transfer function H_{p,m,n}(s) of the linear post filter (H_{p,m,n}).

4. Arrangement according to claim 1, further comprising:
at least one adding device, which is configured and arranged such to generate a total signal uₜ by combining said excitation signal u with said multi-modal distortion u_{d};
a second parameter detector (D₃, D′₃), which is configured and arranged such to generate based on said measurement signal p linear parameters Pₜₒₜ, whereas the linear parameters Pₜₒₜ describe the relationship between said total signal uₜ and said measurement signal p; and
a total transfer element which is configured and arranged such to generate based on said linear parameters Pₜₒₜ and said total signal uₜ an estimate p′ of said measurement signal p;
a second subtraction element which is configured and arranged such to generate an error signal e such that the error signal e describes the deviation between said measurement signal p and said estimate p′; whereas said first parameter detector (D₁, D′₁) is configured to minimize said error signal e and to generate based on said linear parameters Pₜₒₜ the distributed parameters P_{d}.

5. Arrangement according to of claim 1, further comprising:
a linear transfer element, which is configured and arranged such to generate based on said multi-modal distortion u_{d} and said linear parameters Pₜₒₜ the total distortion p_{d} in said measurement signal p; and
a third subtraction element, which is configured and arranged such to generate based on the difference between the measurement signal p and the total distortion p_{d} a linearized measurement signal pₒᵤₜ, whereas the linearized measurement signal pₒᵤₜ contains a linear output signal pₗᵢₙ of said transducers and an ambient signal pₛ generated by an external source.

6. Arrangement according to claim 1, further comprising at least one of the following elements:
an electric sensor, which is configured and arranged such to measure an electric state variable of said transducer to generate an electric measurement signal i, whereas said electric measurement signal i is different form said electrical excitation signal u supplied to the transducer;
a third parameter detector (D₂), which is configured and arranged such to generate based on electrical measurement signal i and said electrical excitation signal u lumped parameters Pₗ, whereas said lumped parameters Pₗ describe the fundamental vibration mode of said transducer with the lowest natural frequency f₀ and determine the properties of said modal activation filter (H_{e,0}) of an order m=0;
a nonlinear network model (Nₗ), which is configured and arranged such to generate based on said excitation signal u and said lumped parameters Pₗ a unimodal distortion signal uₗ, whereas the unimodal distortion signal uₗ represents the signal distortion generated by the fundamental vibration mode of the order m=0;
an adder, which is configured and arranged such to generate based on the excitation signal u and said unimodal distortion signal uₗ a distorted excitation signal u_{c}; and
a nonlinear wave model (N_{d}), which is configured and arranged such to generate based on said distorted excitation signal u_{c} and said distributed parameters P_{d} said multi-modal distortion u_{d}.

7. Arrangement according to claim 1, further comprising
a unimodal synthesis element, which is configured and arranged such to generate based on said network model (Nₗ) and said lumped parameters Pₗ a unimodal compensation signal vₗ, whereas the unimodal compensation signal vₗ represents a unimodal distortion signal uₗ generated by said transducers contributing to said nonlinear total distortion p_{d} in the output signal p(rₐ); and
a fourth subtraction element, which is configured and arranged such to generate based on a difference between the control signal v_{c} and said unimodal compensation signal vₗ the excitation signal u of said transducer.

8. Method for converting an input signal v into an output signal p(rₐ) by using an electro-mechanical transducer and for reducing nonlinear total distortion p_{d} in said output signal p(rₐ), whereas the nonlinear total distortion p_{d} contains multi-modal distortion u_{d} which are generated by nonlinear partial vibration of mechanical transducer components, the method comprising:
generating an electrical excitation signal u based on the input signal v;
exciting said transducers with said electrical excitation signal u;
measuring at least one mechanical or acoustical state variable (p(rₛ)) of said transducer;
generating a measurement signal p, which describes said measured state variable;
assigning initial values to distributed parameters P_{d} of a nonlinear wave model (N_{d}), whereas the distributed parameters P_{d} comprise
modal information H_{e,m}(s), which represents at least one activation mode, whereas the activation mode activates the nonlinear partial vibration of the mechanical components; and
multi-modal information H_{s,m,n}(s) which represents the nonlinear influence of the activation mode on transfer modes, whereas the transfer modes generate output signal p(rₐ);
generating a modal activation signal qₘ based on said input signal v and said modal information H_{e,m}(s), whereas the modal activation signal qₘ describes the vibration state of an activation mode;
generating a multi-modal signal w_{m,n} based on said input signal v and multi-modal information H_{s,m,n}(s), whereas the multi-modal signal w_{m,n} describes the nonlinear relationship between said modal activation signal qₘ and said multi-modal distortion u_{d};
generating a distortion contribution u_{m,n} based on said modal activation signal qₘ and said multi-modal signal w_{m,n}, whereas said distortion contribution u_{m,n} describes components of said multi-modal distortion u_{d};
generating updated values of said distributed parameters P_{d} based on said measurement signal p and distortion contribution u_{m,n}.

9. Method for converting an input signal v into an output signal p(rₐ) by using an electro-mechanical transducer and for reducing nonlinear total distortion p_{d} in said output signal p(rₐ), whereas the nonlinear total distortion p_{d} contains multi-modal distortion u_{d} which are generated by nonlinear partial vibration of mechanical transducer components, the method comprising:
generating distributed parameters P_{d} of a nonlinear wave model (N_{d}), whereas said distributed parameters P_{d} comprise
modal information H_{e,m}(s), which represents at least one activation mode, whereas the activation mode activates the nonlinear partial vibration of the mechanical components; and
multi-modal information H_{s,m,n}(s), which represents the nonlinear influence of the activation mode on transfer modes, whereas the transfer modes generate the output signal p(rₐ);
generating a modal activation signal qₘ based on said input signal v and said modal information H_{e,m}(s), whereas the modal activation signal qₘ describes the vibration state of an activation mode;
generating a multi-modal signal w_{m,n} based on said input signal v and said multi-modal information H_{s,m,n}(s), whereas the multi-modal signal w_{m,n} describes a nonlinear relationship between said modal activation signal qₘ and said multi-modal distortion u_{d};
generating a distortion contribution u_{m,n} based on said modal activation signal qₘ and said multi-modal signal w_{m,n}, whereas said distortion contribution u_{m,n} describes components of said multi-modal distortion u_{d};
generating a multi-modal compensation signal v_{d} based on said distortion contribution u_{m,n};
generating a control signal v_{c}=v−v_{d} based on said input signal v and said multi-modal compensation signal v_{d};
generating an excitation signal u based on said control signal v_{c}; and
supplying the excitation signal u to the electrical input of said transducers.

10. Method according to claim 8, further comprising at least one of the following steps:
generating a powered signal B_{m,n} by setting said modal activation signal qₘ to the power with the exponent n−1;
generating a nonlinear source signal z_{m,n} by multiplying said powered signal B_{m,n} with said multi-modal signal w_{m,n}; and
generating said distortion contribution u_{m,n} of modal order m and nonlinear order n based on linear filtering of said source signal z_{m,n}, whereas the linear filtering has a transfer function H_{p,m,n}(S) which is determined by the distributed parameters P_{d}.

11. Method according to claim 8, further comprising:
generating a total signal uₜ based on said excitation signal u and said multi-modal distortion signal u_{d};
generating linear parameters Pₜₒₜ based on said excitation signal u and said measurement signal p, whereas the linear parameters Pₜₒₜ describe a linear relationship between said total signal uₜ and said measurement signal p;
generating an estimated signal p′ based on the total signal uₜ and said linear parameters Pₜₒₜ, whereas the estimated signal p′ describes the measurement signal p;
generating an error signal e which describes the deviation between said measurement signal p and said estimated signal p′; and
generating said distributed parameters P_{d} by minimizing said error signal e based on said linear parameters Pₜₒₜ.

12. Method according to claim 8, further comprising:
generating a linearized measurement signal pₒᵤₜ based on said measurement signal p and said excitation signal u by using said distributed parameters P_{d} and said linear parameters Pₜₒₜ, whereas the linearized measurement signal pₒᵤₜ contains a linear output signal pₘ of said transducer and an ambient signal pₛ generated by an external source.

13. Method according to claim 8, further comprising:
generating a diagnostic information I based on said distributed parameters P_{d}, whereas the diagnostic information I reveals the physical causes of the nonlinear total distortion p_{d} in the output signal p(rₐ) and is used for improving the design and manufacturing process of said transducer.

14. Method according to claim 8, further comprising at least one of the following steps:
generating an electrical measurement signal i by measuring an electrical state variable of said transducer, whereas said electric measurement signal i is different form said electrical excitation signal u supplied to the input of said transducer;
generating lumped parameters Pₗ of a network model (Nₗ) based on said electrical measurement signal i and said electrical excitation signal u;
generating modal information H_{e,0}(s) based on said lumped parameters Pₗ, wherein the modal information H_{e,0}(s) describes the frequency response of the fundamental vibration mode of the order m=0 with the lowest natural frequency f₀;
generating a unimodal distortion signal uₗ based on said excitation signal u and said modal information H_{e,0}(s), whereas the unimodal distortion signal uₗ represents the signal distortion generated by the fundamental vibration mode of order m=0;
generating a distorted excitation signal u_{c} based on the excitation signal u and said unimodal distortion signal uₗ;
generating a modal activation signal q₀ of the order m=0 based on said excitation signal u and said modal information H_{e,0}(s);
generating a multi-modal signal w_{0,n} based on said distorted excitation signal u_{c} and said multi-modal information H_{s,0,n}(s) provided in said distributed parameters P_{d}; and
generating said multi-modal distortion u_{d} based on said modal activation signals q₀ and said multi-modal signal w_{0,n}.

15. Method according to claim 8, further comprising:
generating a unimodal compensation signal vₗ based on control signal v_{c} and lumped parameters Pₗ of a network model (Nₗ); and
generating an excitation signal u based on the difference between the control signal v_{c} and said unimodal compensation signal vₗ.
